(19) United States
(12) Patent Application Publication
(10) Pub. No.: US 2026/0068877 A1
(43) Pub. Date: Mar. 12, 2026

(54) COMPOSITION

(71) Applicant: ASPIRE TECHNOLOGY GROUP LTD, St Albans (GB)

(72) Inventor: Gary Brierley, St Albans (GB)

(73) Assignee: ASPIRE TECHNOLOGY GROUP LTD, St Albans (GB)

(21) Appl. No.: 19/319,235

(22) Filed: Sep. 4, 2025

(30) Foreign Application Priority Data
Sep. 6, 2024 (EP) 24199064.7

(51) Int. Cl. A01N 25/30; A01N 25/02; A01N 37/02; A01N 43/16; A01P 1/00; A01P 19/00

(52) U.S. Cl. CPC A01N 25/30; A01N 25/02; A01N 37/02; A01N 43/16; A01P 1/00; A01P 19/00

(57) ABSTRACT

The present invention concerns an aqueous composition comprising a sugar ester, a dialkyl ester, a humectant and one or more surfactants.

### FIELD OF INVENTION

The present invention concerns a biocidal aqueous composition that is biodegradable, with low to no toxicity and is less harmful on the environment compared to known disinfectants. The advantageous biocidal composition may be used in a variety of applications and on a wide range of surfaces.

### BACKGROUND

Reducing bacterial infections is a global health priority. Common bacterial infections were associated with 7.7 million i.e., one in eight deaths, in 2019 according to studies by the Global Research on Antimicrobial Resistance Project.

Biofilm formation plays a significant role in the spread of bacterial infections. Biofilm formation is a process by which microorganisms attach to and grow on surfaces irreversibly by producing polymers that enable matrix formation. These microbial communities can be established on almost any surface and exhibit radically reduced susceptibility to antimicrobial agents.

Biocidal agents, for example disinfectants are widely used for limiting the spread of infections and for removing bacteria and other microorganisms from various surfaces such as those in the home, clinical settings and the food and drinks industry. However, most disinfectants are potentially harmful or toxic to humans and animals. For example, traditional disinfectants which often include chlorine-releasing agents, alcohols or quaternary ammonium compounds pose health risks such as skin, eye or respiratory irritation, asthma and developmental and reproductive toxicity. These substances can also be fatal to plant species if allowed to build up in soil and can damage surfaces causing the lifespan of items to be shortened.

Therefore, the provision of biocidal compositions that are less environmentally damaging, based on biodegradable ingredients and less toxic is desirable.

The inventor has considered these and other problems and has surprisingly found that the present invention can address these and other needs.

### SUMMARY OF INVENTION

The present invention concerns a biocidal aqueous composition comprising a sugar ester, a dialkyl ester, a humectant and one or more surfactants. The aqueous composition is a colloid or a suspension, and in each instance the aqueous component forming the continuous phase of the aqueous composition is water.

The aqueous composition demonstrates effective biocidal activity. It is envisaged that microorganisms are attracted to the sugar-based components of the aqueous composition in the formulation, which also form an inhospitable environment that the microorganisms are trapped in and subsequently killed by. As used herein, the terms “composition” and “formulation” may be interchangeable.

It is also envisaged that the aqueous composition acts on the calcium ionic bonds present in bacterial membranes. Calcium is essential for bacterial cell integrity and metabolism and plays a key role in viral infection and fungi metabolism. Calcium also plays an important role in bacterial biofilm formation, helping to strengthen and stabilize the biofilm matrix. Biofilms are particularly difficult to remove because a biofilm matrix mediates cellular adhesion to surfaces and neighbouring cells, leading to the development of three-dimensional biofilm structures. A biofilm matrix also forms the immediate environment for resident bacteria, which retains water, nutrients, and extracellular enzymes. This environment protects bacteria from disinfectants, antibiotics, environmental stresses, and the host immune system. It is envisaged that the combination of components in the aqueous composition of the formulation interacts with the calcium ionic bonds in a bacterial membrane and/or biofilm matrix, helping to reduce surface tension and structural integrity. This enables the cells to be penetrated and killed more easily.

The active aqueous compositions comprise biodegradable and naturally derived components so can be broken down without having a negative impact on the environment. As such, the aqueous compositions are less environmentally damaging than other available disinfectants which require harsh and toxic chemicals to kill microorganisms. Surprisingly, the aqueous composition comprises a blend of components which are less toxic to the user and less harmful to the environment but are at least as effective as disinfectants which include for example peracids, bleaches or quaternary ammonium compounds.

The aqueous compositions of this disclosure can be applied as a biocide or disinfectant to various surfaces and remain stable and active against microorganisms for long periods of time after application. As a result, the aqueous compositions can be used in a variety of settings including kitchens, bathrooms, hospitals, care facilities, food and animal handling and processing centres, supermarkets, cosmetic and pharmaceutical manufacturing facilities and recycling centres. The aqueous compositions may also be used on a variety of surfaces including glass, metals, ceramics, plastics, polymers and other hard, non-porous surface types.

The skilled person will understand that the aqueous composition may be diluted before use, typically with water. The diluted form of the composition may comprise the aqueous composition in an amount of at least 0.01 wt. % based on weight of the diluted composition, or at least 0.03 wt. %, or at least 3 wt. %, or at least 7 wt. %. The diluted form of the composition may comprise the aqueous composition in an amount of up to 15 wt. %, based on weight of the diluted composition, or up to 10 wt. %, or up to 7 wt. %, or up to 3 wt. %. Alternatively the diluted form of the composition may comprise the aqueous composition in an amount of 0.01 wt. % to 15 wt. % based on the weight of the diluted composition, optionally 0.01 wt. % to 10 wt. %, or 0.03 wt. % to 7 wt. %, or preferably 0.03 wt. % to 3 wt. % based on the weight of the diluted composition.

The present invention extends to the method of manufacturing the aqueous compositions described herein. Under some circumstances, it is envisaged that some or all of the sugar ester, dialkyl ester, humectant and one or more surfactants of the aqueous composition may form interlinking bonds during the method of production. The sugar ester, dialkyl ester, humectant and one or more surfactants in the aqueous composition are therefore intended both to cover the discrete substances or their combination through covalent or non-covalent bonds.

### DETAILED DESCRIPTION OF THE INVENTION

The present invention concerns an aqueous composition that has biocidal properties.

The terms “biocide” or “biocidal” are intended to refer to a substance that destroys, deters, renders harmless, prevents the action of or otherwise exerts a controlling effect on harmful, undesired organisms. The term also encompasses more specific terms such as bactericidal, viricidal, fungicidal and germicidal. Typically, a biocidal active ingredient is the substance that has a controlling effect on harmful, undesired organisms. A biocide typically comprises a biocidal active ingredient but may also comprise additional components. Biocides can be synthetic or naturally occurring, for example derived from bacteria or plants.

The term “disinfectant” is intended to refer to a biocidal product used to inactivate or destroy microorganisms, such as bacteria and viruses on inert surfaces. Disinfectants can also be used to destroy microorganisms on the skin and mucous membrane. Disinfectants generally work by destroying the cell wall and/or membrane of microorganisms or by interfering with their metabolism by inducing cell responses such as increased levels of reactive oxygen species, increased stress response and membrane damage.

The aqueous composition may comprise a sugar ester, a dialkyl ester, a humectant and one or more surfactants. Optionally the aqueous composition may further comprise a chelating agent and a pH buffer.

The biocidal aqueous composition comprises a sugar ester, for example a sucrose ester, fructose ester, lactose ester or glucose ester. The term “sugar ester” refers to a compound derived from the esterification of a sugar and a fatty acid. As such a sugar ester contains an ester group (RCOOR′) formed between an organic acid (RCO₂H) and an alcohol (R′OH). Sugar esters are often biodegradable and have good stabilizing properties especially when incorporated into colloidal systems or emulsions. Preferably, the sugar ester is a sucrose ester such as sucrose stearate, sucrose distearate, sucrose dilaurate, sucrose palmitate or combinations thereof. Preferably the sugar ester is sucrose stearate or sucrose distearate, which are commercially available derivatives of stearic acid. The sugar ester may be present in an amount of 1 to 45 wt. % based on the weight of the aqueous composition, preferably 2 to 35 wt. %, 3 to 25 wt. % or 4 to 15 wt. % based on the weight of the aqueous composition.

Throughout this document, the disclosure of a compositional range (e.g. weight range) of a genus also directly and unambiguously applies to each sub-genus and each individual member of the genus. For example, the sugar ester is optionally present in a total amount of 1 to 45 wt. % based on the weight of the aqueous composition, preferably 2 to 35 wt. %, 3 to 25 wt. % or 4 to 15 wt. % based on the weight of the aqueous composition. Preferred sugar esters include sucrose esters such as sucrose stearate or sucrose distearate. Therefore, the reader should directly and unambiguously understand that the weight ranges also disclose sucrose esters in a total amount of 1 to 45 wt. % 2 to 35 wt. %, 3 to 25 wt. % or 4 to 15 wt. % based on the weight of the aqueous composition. The reader should directly and unambiguously understand that the weight ranges also disclose sucrose stearate or sucrose distearate in an amount of 1 to 45 wt. % 2 to 35 wt. %, 3 to 25 wt. % or 4 to 15 wt. % based on the weight of the aqueous composition.

The aqueous composition comprises a dialkyl ester of an acid selected from succinic acid, carbonic acid, glutaric acid or adipic acid. The term “dialkyl ester” refers to a compound derived from the esterification of a carboxylic acid with an alkyl alcohol. As such a dialkyl ester contains an ester group (RCOOR′) formed between a carboxylic acid (RCO₂H), preferably an organic carboxylic acid, and an alkyl alcohol (R′OH). Preferably dialkyl refers to dimethyl, diethyl, dipropyl, dibutyl or a mixture of methyl, ethyl, propyl or butyl groups such as methylethyl. Preferably, the dialkyl ester is dimethyl succinate, dimethyl carbonate, dimethyl glutarate or dimethyl adipate. Most preferably the dialkyl ester is dimethyl succinate. The dialkyl ester may be present in an amount of 1 to 45 wt. % based on the weight of the aqueous composition, preferably 2 to 35 wt. %, 3 to 25 wt. % or 4 to 15 wt. % based on the weight of the aqueous composition.

The aqueous composition comprises a humectant. A humectant is a hygroscopic (water-absorbing) compound often used to attract and/or retain moisture. Humectants may also be used to increase the solubility of other ingredients in a composition. As such, the humectant aids the blending of the components in the aqueous composition. Preferably the humectant is an alkyl polyol or combination of alkyl polyols, wherein the term polyol is intended to refer to a compound containing two or more hydroxyl (—OH) groups. The alkyl polyol may be an alkyl diol such as propylene glycol, butylene glycol or hexylene glycol. The alkyl polyol may be an alkyl triol such as glycerol (also referred to as glycerine or glycerin in the art) or an alkyl polyol such as sorbitol or xylitol. Preferably the alkyl polyol is glycerol. The humectant is present in an amount of 1 to 40 wt. % based on the weight of the aqueous composition, preferably 2 to 30 wt. %, 4 to 20 wt. % or 6 to 15 wt. % based on the weight of the aqueous composition.

The aqueous composition comprises one or more surfactants. Surfactants, also known as surface active agents, are chemical compounds that decrease the surface tension or interfacial tension between two liquids, a liquid and a gas, or a liquid and a solid. These suspensions help to stabilise the colloid or suspension. The one or more surfactants are present in an amount of 2 to 45 wt. % based on the weight of the aqueous composition, preferably 4 to 35 wt. %, 7 to 25 wt. % or 10 to 15 wt. % based on the weight of the aqueous composition. The one or more surfactants may comprise sugar-derived surfactants, for example the one or more surfactants may comprise a glycoside or combination of glycosides. Glycosides refer to compounds which contain a sugar molecule bound to another molecule via a glycosidic bond. A glycosidic bond is often formed between a hemiacetal or hemiketal group of a sugar molecule (or saccharide) and the hydroxyl group of another molecule such as an alcohol. Sugar esters are therefore excluded from this definition and the skilled person will understand that the one or more surfactants do not include sugar esters or dialkyl esters. Glycosides may include for example include glucosides, fructosides, sucrosides or lactosides. Preferably, the one or more surfactants comprise a glucoside such as an alkylglucoside or an alkylpolyglucoside. For example, the surfactant may comprise capryl glucoside, lauryl glucoside, coco glucoside or combinations thereof. Glucosides are preferred because glucose-derived substances are easily taken up or absorbed and metabolised by bacteria. Glucosides are also biodegradable. It is envisaged that glucoside-based surfactants attract microorganisms towards the aqueous compositions due to the sugar component of the compounds, leading to subsequent eradication of the microorganisms.

For all sugar-based components of the aqueous composition (for example sugar esters and sugar-derived surfactants) it is intended both to cover the discrete D and L forms of the sugars as well as the combination or mixture of the D and L forms of the sugars. The D and L forms of a sugar are non-superimposable mirror images of each other. The skilled person will be able to select a suitable method to separate D- and L-isomers if required, such as crystallisation, chromatography, or chemical or enzymatic methods.

The aqueous composition may comprise one or more chelating agents. The term “chelating agent” is intended to take its usual meaning in the art of a chemical compound that binds to metal ions. The one or more chelating agents may be present in an amount of 0.25 to 10 wt. % based on the weight of the aqueous composition, preferably 0.5 to 8 wt. %, 0.75 to 6 wt. % or 1 to 4 wt. % based on the weight of the aqueous composition. The one or more chelating agents may comprise commercially available chelators such as, but not limited to tetrasodium N,N-bis(carboxymethyl)-L-glutamate (GLDA), ethylenediaminetetraacetic acid (EDTA), citric acid or ethylenediamine-N, N′-disuccinic acid (EDDS). Tetrasodium N,N-bis(carboxymethyl)-L-glutamate (GLDA) is a preferred chelating agent because it is biodegradable and is based on based upon L-glutamic acid which is a natural and renewable raw material.

It is envisaged that including a chelating agent in the aqueous composition removes ions that could interfere with the biocidal activity of the formulation.

The skilled person will understand that the one or more chelating agents do not include a sugar esters, dialkyl esters or glycosides.

In addition to the components described above, the aqueous composition comprises an aqueous component.

The aqueous component of the aqueous composition forms the continuous phase in which other substances are dispersed and/or suspended. A sufficient amount of water is present to form the continuous phase. The water content is optionally 20 to 90 wt. % based on the weight of the aqueous composition. The skilled person will be able to determine the specific amount of water required as water is the balance for the aqueous composition i.e., the amount of water will bring the total amount of all of the components in the aqueous composition to 100 wt. %. The water typically has a pH of 6-8, 6.5-7.5 or 7 and can fresh water, tap water, deionised or purified water.

The aqueous composition may be a colloid or a suspension, and in each instance the aqueous component forming the continuous phase of the aqueous composition is water.

The aqueous composition may be in the form of a colloid or a suspension. A colloid is a homogeneous non-crystalline substance consisting of large molecules or ultramicroscopic particles of one substance dispersed through a second substance. Colloids include gels, sols, and emulsions; the particles do not settle, and cannot be separated out by ordinary filtering or centrifuging like those in a suspension. A suspension is a composition in which solid particles are dispersed in a continuous liquid phase.

The structure of the colloid can be examined by light-scattering techniques that are familiar to a person operating in this technical field. For example, dynamic light scattering can be used to detect the size of a colloidal particle by measuring how fast they diffuse. This method involves directing laser light towards a colloid. The scattered light will form an interference pattern, and the fluctuation in light intensity in this pattern is caused by the Brownian motion of the particles. If the apparent size of the particles increases due to them clumping together via aggregation, it will result in slower Brownian motion. This technique can confirm that aggregation has occurred if the apparent particle size is determined to be beyond the typical size range for colloidal particles. For example, many aqueous compositions of the present disclosure are oil in water emulsions.

The structure of the suspension can be examined by light-scattering techniques that are familiar to a person operating in this technical field. For example, as with colloids, suspended particle size can be assessed using dynamic light scattering to determine mean particle size and size distribution, for example.

The aqueous composition may have a pH in the range of 6-8, preferably 6.5-7.5 or 7. An advantage of having a pH at or around neutral is that the aqueous compositions can be used on any type of surface without damaging them. The aqueous compositions are also safer to use and so personal protective equipment that is often required for compositions with a very high or very low pH such as peroxides, bleaches or sodium hydroxide is not needed. Despite the less harmful and less toxic nature of the aqueous compositions of the present invention, the aqueous compositions are surprisingly as effective, and in some cases more effective at reducing microorganism populations as traditional disinfectants.

The skilled person may adjust the pH of the aqueous compositions by adding a pH buffer. The pH buffer may be present in amount of 0.025 to 2 wt. %, preferably 0.05 to 1 wt. %, 0.075 to 0.75 wt. % or 0.1 to 0.5 wt. % based on the weight of the aqueous composition. Any suitable pH buffer may be included and the skilled person will be able to select a suitable one. Preferred pH buffers include citric acid, acetic acid, carbonic acid, sodium hydroxide, Tris, HEPES or monopotassium phosphate. When citric acid is used as a chelating agent, an alternative pH buffer may be required. If citric acid is used as a chelating agent and pH buffer the skilled person will be able to adjust the preferred amounts of these components accordingly.

Optionally, the aqueous composition may further comprise one or more additives such as fragrances, preservatives, plasticisers, soaps, detergents, abrasives, bleaches, dyes, gelling agents, solvents, builders, enzymes, oxidisers, acids, alkalis, reducing agents, foaming agents, colouring agents, thickeners, emulsifiers, rinse aids, viscosity modifiers, polymers, allergy inhibitors and film forming agents.

The present invention concerns use of the aqueous compositions as biocidal agents in wide variety of applications. For example, the aqueous compositions may be used on surfaces and equipment in transport facilities such as airports, bus stations, train stations, shipping terminals, service stations as well as in vehicles such as cars, trucks, trains, trailers, boats, ships, tanks, buses, airplanes, helicopters.

The aqueous compositions may also be used on surfaces and equipment in emergency service buildings and vehicles such as fire stations and fire engines, police vehicles, police stations and prisons as well as courts and crime scenes, hospitals, medical and dental offices and clinics, healthcare facilities, operating rooms/theatres and autopsy rooms. This includes for example tools, surgical equipment, protective clothing, bedding and scanners.

The aqueous compositions may also be on surfaces and equipment used in educational or care facilities such as day care centres, nurseries, schools and colleges as well as nursing homes, funeral homes and cadaver processing areas.

The aqueous compositions may be used in on surfaces and equipment animal care or processing facilities such as veterinary clinics, animal laboratories, animal research centres, animal quarantine areas, animal holding areas, farms, kennels, animal breeding facilities, breeding establishments, animal husbandry establishments, grooming establishments, animal housing facilities, zoos, tack shops, pet shops, meat and poultry plants and hatcheries.

The aqueous compositions may also be used on surfaces and equipment in recreational facilities such as gyms, playgrounds, campgrounds, hotels, libraries, museums, theatres, cinemas, bowling alleys, sports arenas and concert venues.

The aqueous compositions may be used on surfaces and equipment in public facilities such as recycling centres, banks, churches and post offices.

The aqueous compositions may be used on surfaces and equipment in facilities that prepare, store or serve food such as restaurants, bars, kitchens, bakeries, dairies, butchers, canneries, beverage plants, fermentation tanks and facilities, supermarkets, wholesale establishments, food storage areas, food handling and processing areas as well as kitchen equipment including refrigerators, ovens, ice machines and utensils.

The aqueous compositions may be used on surfaces and equipment in residential, commercial and public bathrooms or washrooms including on toilets, sinks, showers, baths and changing facilities.

The aqueous compositions may be used in on surfaces and equipment manufacturing facilities and laboratories such as cosmetic, medical device, biotechnology, computer and pharmaceutical facilities as well as in retail, storage and distribution facilities.

The aqueous compositions may be used in water cooling towers, commercial water circulation systems, irrigation systems, water heating and cooling systems, water purification systems, reverse osmosis systems, filtration systems, sanitisation systems, condensers, evaporators and pasteurizers.

The aqueous compositions may be used in agricultural facilities such as for treatment of meat, seafood, poultry, fruit and vegetable, nut processing plants, in tobacco plant premises, for disease control on fruits and vegetables, treatment of fruit and vegetable processing waters, in humidification water for post-harvest crops in storage, greenhouses, foliar sprays, cut flowers, and for treatment of roots, turf, seed beds and soil.

The aqueous compositions may be used aqueous treatment fluids in subterranean oilfield and gas-field well operations such as well drilling, formation fracturing, productivity enhancement and secondary recovery, drilling muds, fracturing fluids, well squeezed fluids, flooding, injection and produced water and pipeline and tank maintenance.

Use of the aqueous compositions as a biocidal agents can also include application to a variety of surfaces, for example glass surfaces, metal surfaces, plastic surfaces, laminated surfaces, glazed surfaces, ceramic surfaces, stone surfaces, wooden surfaces upholstery, wallpaper, painted surfaces, countertops, stovetops, bathroom surfaces, kitchen surfaces, food, meat, crops, hard, non-porous surfaces, fabric, conductive surfaces, rubber surfaces and leather surfaces.

The present invention concerns a method of manufacturing the aqueous compositions described herein.

The process by which the aqueous compositions are manufactured allows components that are often difficult to combine to be blended into a colloid or suspension without compounds falling out of solution.

Under some circumstances, it is envisaged that some or all of the sugar ester, dialkyl ester, humectant and one or more surfactants may form interlinking bonds during the method of production. The sugar ester, dialkyl ester, humectant and one or more surfactants in the aqueous composition are therefore intended both to cover the discrete substances or their combination through covalent or non-covalent bonds.

The method for manufacturing the aqueous compositions described herein comprises the steps of:
(i) mixing a sugar ester and a dialkyl ester with water,
(ii) adding one or more surfactants, and
(iii) adding a humectant.

The method may be performed at room temperature. Increasing the temperature the method is performed at may increase the speed at which the components are blended together, for example the method may be performed at any temperature within a range of 25° C. to 65° C., optionally 35° C. to 60° C., optionally 45° C. to 55° C. or 50° C.

In steps (i), (ii) and (iii) of the method described above, the components may be mixed together by stirring at a speed of at least 200 rpm. Electromechanical stirring may be used but the method of stirring is not particularly limited.

In step (i), the sugar ester is added in an amount of 1 to 45 wt. % based on the weight of the aqueous composition, preferably 2 to 35 wt. %, 3 to 25 wt. % or 4 to 15 wt. % based on the weight of the aqueous composition. The sugar ester may comprise a sucrose ester, fructose ester, lactose ester or glucose ester. Preferably the sugar ester is a sucrose ester such as sucrose stearate, sucrose distearate, sucrose dilaurate, sucrose palmitate or combinations thereof. Preferably the sugar ester is sucrose stearate or sucrose distearate, which are commercially available derivatives of stearic acid. The dialkyl ester is added in an amount of 1 to 45 wt. % based on the weight of the aqueous composition, preferably 2 to 35 wt. %, 3 to 25 wt. % or 4 to 15 wt. % based on the weight of the aqueous composition. The dialkyl ester may comprise dialkyl ester of an acid selected from succinic acid, carbonic acid, glutaric acid or adipic acid. Preferably dialkyl refers to dimethyl, diethyl, dipropyl, dibutyl or a mixture of methyl, ethyl, propyl or butyl groups such as methylethyl. Preferably, the dialkyl ester is dimethyl succinate, dimethyl carbonate, dimethyl glutarate or dimethyl adipate. Most preferably the dialkyl ester is dimethyl succinate. The amount of water is 20 to 90 wt. % based on the weight of the aqueous composition. The amount of water provides the balance for the aqueous composition.

In step (ii), one or more surfactants are added in an amount of 2 to 45 wt. % based on the weight of the aqueous composition, preferably 4 to 35 wt. %, 7 to 25 wt. % or 10 to 15 wt. % based on the weight of the aqueous composition. The one or more surfactants may comprise sugar-derived surfactants, for example the one or more surfactants may comprise a glycoside or combination of glycosides. Glycosides may include for example include glucosides, fructosides, sucrosides or lactosides. Preferably, the one or more surfactants comprise a glucoside such as an alkylglucoside or an alkylpolyglucoside. For example, the surfactant may comprise capryl glucoside, lauryl glucoside, coco glucoside or combinations thereof.

In step (iii) a humectant is added in an amount of 1 to 40 wt. % based on the weight of the aqueous composition, preferably 2 to 30 wt. %, 4 to 20 wt. % or 6 to 15 wt. % based on the weight of the aqueous composition. Preferably the humectant is an alkyl polyol or combination of alkyl polyols. The alkyl polyol may be an alkyl diol such as propylene glycol, butylene glycol or hexylene glycol. The alkyl polyol may be an alkyl triol such as glycerol (also referred to as glycerine or glycerin in the art) or an alkyl polyol such as sorbitol or xylitol. Preferably the alkyl polyol is glycerol.

One or more chelating agents may be added to the mixture in step (i) in an amount of 0.25 to 10 wt. % based on the weight of the aqueous composition, preferably 0.5 to 8 wt. %, 0.75 to 6 wt. % or 1 to 4 wt. % based on the weight of the aqueous composition. The one or more chelating agents may comprise tetrasodium N,N-bis(carboxymethyl)-L-glutamate (GLDA), ethylenediaminetetraacetic acid (EDTA), ethylenediamine-N,N′-disuccinic acid (EDDS) or citric acid or combinations thereof. Preferably the chelating agent is tetrasodium N,N-bis(carboxymethyl)-L-glutamate (GLDA).

The pH of the aqueous compositions is preferably in the range of 6-8, preferably 6.5-7.5 or 7. Accordingly it may be necessary to add a pH buffer to the mixture until the pH of the composition is at a desirable value. The pH buffer may comprise citric acid, but the skilled person will be able to select any suitable buffer to adjust the pH of the formulation. The pH buffer may be present in amount of 0.025 to 2 wt. % based on the weight of the aqueous composition, preferably 0.05 to 1 wt. %, 0.075 to 0.75 wt. % or 0.1 to 0.5 wt. % based on the weight of the aqueous composition.

Optionally, the aqueous composition may be diluted, typically with water. Therefore, the method described herein may comprise an additional step of diluting the aqueous composition with water. The diluted form of the composition may comprise the aqueous composition in an amount of at least 0.01 wt. % based on weight of the diluted composition, or at least 0.03 wt. %, or at least 3 wt. %, or at least 7 wt. %. The diluted form of the composition may comprise the aqueous composition in an amount of up to 15 wt. %, based on weight of the diluted composition, or up to 10 wt. %, or up to 7 wt. %, or up to 3 wt. %. Alternatively, the diluted form of the composition may comprise the aqueous composition in an amount of 0.01 wt. % to 15 wt. % based on the weight of the diluted composition, optionally 0.01 wt. % to 10 wt. %, or 0.03 wt. % to 7 wt. %, or preferably 0.03 wt. % to 3 wt. % based on the weight of the diluted composition.

### EXAMPLES

The present invention can be further understood by reference to the following non-limiting Examples.

### Example 1: Example Preparation of Aqueous Composition

A tank containing water was heated to 50° C. and sucrose distearate, dimethyl succinate and GLDA were added whilst stirring. The temperature was reduced to 40° C. and glucosides were added. Glycerol was then added to the mixture which was allowed to cool to room temperature. The pH of the resulting aqueous composition was adjusted to pH 7 using citric acid.

### Example 2: Evaluation of Biocidal Activity

The aqueous composition prepared in example 1 was tested to evaluate the bactericidal activity.

Samples of four different bacteria, Pseudomonas aeruginosa, Staphylococcus aureus, Escherichia coli and Enterococcus hirae were treated with the aqueous composition.

In each case a significant reduction in bacterial activity was observed demonstrating that the less toxic, and more environmentally friendly aqueous compositions are effective at killing bacteria. Accordingly, the use of biodegradable, naturally derived components does not sacrifice or compromise the biocidal efficacy of the compositions.

### Example 3: Example Preparation of Further Aqueous Compositions

Further aqueous compositions are prepared in accordance with the method of example 1 with components in the amounts provide in table 1 below.

TABLE 1

| Component | Amount |
|---|---|
| Water | Balance |
| Sucrose distearate | 4-15% |
| Dimethyl succinate | 4-15% |
| Glycerine | 10-15% |
| Citric acid | 0.1-0.5% |
| Capryl glucoside | 2-5% |
| Lauryl glucoside | 2-5% |
| Coco glucoside | 2-5% |
| GLDA | 1-4% |

### Example 4: Evaluation of Bactericidal Activity

Quantitative suspension tests are performed to establish the biocidal activity of the compositions of table 1.

### Test Procedure

TABLE 2

| | |
|---|---|
| Test bacteria | Staphylococcus aureus (NCTC 10788) |
| | Pseudomonas aeruginosa (NCTC 6749) |
| | Escherichia coli (NCTC 10538) |
| | Enterococcus hirae (NCTC 12367) |
| Neutralizer | Tween 80 (30 g/l) |
| fluid | Sodium lauryl sulphate (4 g/l) |
| | Lecithin (3 g/l) |
| Interfering | Bovine serum albumin (BSA) |
| substance | 0.3% BSA concentration (clean conditions) |
| | 3% BSA concentration (dirty conditions) |
| Contact time | 1 minute |
| Test | 20° C. |
| temperature | |
| Inhibition | Dilution/neutralization |
| method | |
| Appearance | Clear solution |
| product | |
| dilution | |

1 ml of the test bacteria is mixed with 1 ml of interfering substance (0.3% or 3% bovine serum albumin). A sample of a composition according to table 1 is added to the mixture. After a contact time of 1 minute, 1 ml of the mixture is removed and added to 9 ml of a neutralizer fluid (see table 2 for details). After a period of 1 minute of neutralization, 1 ml of the neutralized mixture is plated to detect surviving test bacteria. All tests are carried out in duplicate.

### Test Results

The results of the testing are displayed in the table 3.

TABLE 3
Sample of composition according to table 1

| | | Log¹⁰ reduction achieved | |
|---|---|---|---|
| | | Clean conditions | Dirty conditions |
| | | (0.3% BSA) | (3% BSA) |
| | Contact | Test | Test |
| Test organism | time | Mean | Mean |
| Pseudomonas | 1 min | >5^{Log10} | >5^{Log10} |
| aeruginosa | | | |
| Staphylococcus aureus | 1 min | >5^{Log10} | >5^{Log10} |
| Escherichia coli | 1 min | >5^{Log10} | >5^{Log10} |
| Enterococcus hirae | 1 min | >5^{Log10} | >5^{Log10} |

The tests are carried out under clean and dirty conditions. The term “clean conditions” is intended to refer to a concentration of 0.3% bovine serum albumin, in accordance with the European Standard. The term “dirty conditions” is intended to refer to a concentration of 3% bovine serum albumin, in accordance with the European Standard. The use of bovine serum albumin as an interfering substance emulates organic soiling and is therefore used to test the efficacy of cleaning products and disinfectants.

When tested in accordance with EN 1276, samples pass the test criteria. Compliance with the test criteria is achieved with 1 minute under clean and dirty conditions. Compositions achieve a mean reduction of >5^{Log 10} with all 4 test organisms under clean and dirty conditions within the test times.

The results demonstrate that compositions prepared according to the invention are effective at killing bacteria including Pseudomonas aeruginosa, Staphylococcus aureus, Escherichia coli and Enterococcus hirae. The results also show that the use of biodegradable, naturally derived components does not sacrifice or compromise the biocidal efficacy of the compositions.

It would be appreciated that the process and components of the invention are capable of being implemented in a variety of ways, only a few of which have been illustrated and described above.

### Paragraphs

Paragraph 1: A biocidal aqueous composition comprising:
(a) a sugar ester;
(b) a dialkyl ester;
(c) a humectant; and
(d) one or more surfactants,
wherein the aqueous composition is a colloid or a suspension.

Paragraph 2: The biocidal aqueous composition of paragraph 1, wherein the sugar ester is a sucrose ester, fructose ester, lactose ester or glucose ester, preferably wherein the sugar ester is a sucrose ester, optionally sucrose stearate or sucrose distearate and is optionally is present in an amount of 1 to 45 wt. % based on the weight of the aqueous composition, preferably 2 to 35 wt. %, 3 to 25 wt. % or 4 to 15 wt. % based on the weight of the aqueous composition.

Paragraph 3: The biocidal aqueous composition of any preceding paragraph, wherein the sugar ester is sucrose stearate and is present in an amount of 1 to 45 wt. % based on the weight of the aqueous composition, preferably 2 to 35 wt. %, 3 to 25 wt. % or 4 to 15 wt. % based on the weight of the aqueous composition.

Paragraph 4: The biocidal aqueous composition of any preceding paragraph, wherein the sugar ester is sucrose distearate and is present in an amount of 1 to 45 wt. % based on the weight of the aqueous composition, preferably 2 to 35 wt. %, 3 to 25 wt. % or 4 to 15 wt. % based on the weight of the aqueous composition.

Paragraph 5: The biocidal aqueous composition of any preceding paragraph, wherein the sugar ester is sucrose distearate and is present in an amount of 4 to 15 wt. % based on the weight of the aqueous composition.

Paragraph 6: The biocidal aqueous composition of any preceding paragraph, wherein the sugar ester is derived from esterification of a sugar and a fatty acid.

Paragraph 7: The biocidal aqueous composition of any preceding paragraph, wherein the dialkyl ester is a dialkyl ester of an acid selected from succinic acid, carbonic acid, glutaric acid or adipic acid, preferably the dialkyl ester is dimethyl succinate, dimethyl carbonate, dimethyl glutarate or dimethyl adipate, more preferably dimethyl succinate and is optionally present in an amount of 1 to 45 wt. % based on the weight of the aqueous composition, preferably 2 to 35 wt. %, 3 to 25 wt. % or 4 to 15 wt. % based on the weight of the aqueous composition.

Paragraph 8: The biocidal aqueous composition of any preceding paragraph, wherein the dialkyl ester is dimethyl succinate, and is optionally present in an amount of 1 to 45 wt. % based on the weight of the aqueous composition, preferably 2 to 35 wt. %, 3 to 25 wt. % or 4 to 15 wt. % based on the weight of the aqueous composition.

Paragraph 9: The biocidal aqueous composition of any preceding paragraph, wherein the dialkyl ester is dimethyl succinate, and is present in an amount 4 to 15 wt. % based on the weight of the aqueous composition.

Paragraph 10: The biocidal aqueous composition of any preceding paragraph, wherein the dialkyl ester is derived from esterification of a carboxylic acid and an alkyl alcohol.

Paragraph 11: The biocidal aqueous composition of any preceding paragraph, wherein the dialkyl ester is not a sugar ester.

Paragraph 12: The biocidal aqueous composition of any preceding paragraph, wherein the humectant is an alkyl polyol or combination of alkyl polyols, preferably an alkyl diol, optionally propylene glycol, butylene glycol or hexylene glycol, or an alkyl triol, optionally glycerol, or an alkyl polyol optionally sorbitol or xylitol, preferably the alkyl polyol is glycerol, and is optionally present in an amount of 1 to 40 wt. % based on the weight of the aqueous composition, preferably 2 to 30 wt. %, 4 to 20 wt. % or 6 to 15 wt. %, based on the weight of the aqueous composition.

Paragraph 13: The biocidal aqueous composition of any preceding paragraph, wherein the humectant is glycerol and is present in an amount of 6 to 15 wt. %, based on the weight of the aqueous composition.

Paragraph 14: The biocidal aqueous composition of any preceding paragraph, wherein the one or more surfactants comprise a glycoside or combination of glycosides.

Paragraph 15: The biocidal aqueous composition of any preceding paragraph, wherein the one or more surfactants comprise one or more glucosides, preferably wherein the glucosides are selected from one or more of capryl glucoside, lauryl glucoside and coco glucoside, optionally wherein the one or more surfactants are present in an amount of 2 to 45 wt. % based on the weight of the aqueous composition, preferably 4 to 35 wt. %, 7 to 25 wt. % or 10 to 15 wt. %, based on the weight of the aqueous composition.

Paragraph 16: The biocidal aqueous composition of any preceding paragraph, wherein the one or more surfactants comprise one or more of capryl glucoside, lauryl glucoside and coco glucoside, and are present in an amount 10 to 15 wt. %, based on the weight of the aqueous composition.

Paragraph 17: The biocidal aqueous composition of any preceding paragraph, wherein the one or more surfactants do not include sugar esters or dialkyl esters.

Paragraph 18: The biocidal aqueous composition of any preceding paragraph, wherein the at least one biocidal active ingredient is a substance that destroys, deters, renders harmless, prevents the action of or otherwise exerts a controlling effect on harmful, undesired organisms.

Paragraph 19: The biocidal aqueous composition of any preceding paragraph, wherein the at least one biocidal active ingredient is selected from: detergents, abrasives, acids, alkalis, bleaches, enzymes, fragrances, preservatives, dyes, thickeners, foaming agents, gelling agents, quaternary ammonium compounds (for example alkyl dimethyl benzyl ammonium chloride, didecyl dimethyl ammonium chloride, octyl decyl dimethyl ammonium chloride, dioctyl dimethyl ammonium chloride, 3-trimethoxysilylpropyldimethyloctadecyl ammonium chloride), chlorine-releasing agents (for example sodium dichloroisocyanurate, calcium hypochlorite, sodium tosylchloramide and trichloroisocyanuric acid), alcohols (for example ethanol and isopropanol), hydrogen peroxide, peracetic acid and acetic acid.

Paragraph 20: The biocidal aqueous composition of any preceding paragraph, wherein the composition achieves a mean reduction of >5^{Log 10} in viable bacteria within 5 minutes.

Paragraph 21: The biocidal aqueous composition of any preceding paragraph, wherein the composition achieves a mean reduction of >5^{Log 10} in viable bacteria within 1 minute.

Paragraph 22: The biocidal aqueous composition of any preceding paragraph, wherein the composition achieves a mean reduction of >6^{Log 10} in viable bacteria within 5 minutes.

Paragraph 23: The biocidal aqueous composition of any preceding paragraph, wherein the composition achieves a mean reduction of >6^{Log 10} in viable bacteria within 1 minute.

Paragraph 24: The biocidal aqueous composition of any of paragraphs 20 to 23, wherein the viable bacteria is at least one of Pseudomonas aeruginosa, Staphylococcus aureus, Escherichia coli, and Enterococcus hirae.

Paragraph 25: A biocidal aqueous composition comprising:
(a) a sucrose ester;
(b) dimethyl succinate;
(c) a humectant; and
(d) one or more surfactants,
wherein the aqueous composition is a colloid or a suspension.

Paragraph 26: A biocidal aqueous composition comprising:
(a) sucrose distearate;
(b) dimethyl succinate;
(c) a humectant; and
(d) one or more surfactants,
wherein the aqueous composition is a colloid or a suspension.

Paragraph 27: A biocidal aqueous composition comprising:
(a) sucrose distearate;
(b) dimethyl succinate;
(c) glycerol; and
(d) one or more surfactants,
wherein the aqueous composition is a colloid or a suspension.

Paragraph 28: A biocidal aqueous composition comprising:
(a) sucrose distearate;
(b) dimethyl succinate;
(c) glycerol; and
(d) one or more of capryl glucoside, lauryl glucoside and coco glucoside,
wherein the aqueous composition is a colloid or a suspension.

Paragraph 29: A biocidal aqueous composition comprising:
(a) 4 to 15 wt. % based on the weight of the aqueous composition of a sucrose ester;
(b) 4 to 15 wt. % based on the weight of the aqueous composition of a dialkyl ester;
(c) 6 to 15 wt. % based on the weight of the aqueous composition of a humectant; and
(d) 10 to 15 wt. % based on the weight of the aqueous composition of one or more surfactants,
wherein the aqueous composition is a colloid or a suspension.

Paragraph 30: A biocidal aqueous composition comprising:
(a) 4 to 15 wt. % based on the weight of the aqueous composition of sucrose distearate;
(b) 4 to 15 wt. % based on the weight of the aqueous composition of dimethyl succinate;
(c) 6 to 15 wt. % based on the weight of the aqueous composition of glycerol; and
(d) 10 to 15 wt. % based on the weight of the aqueous composition of one or more of capryl glucoside, lauryl glucoside and coco glucoside,
wherein the aqueous composition is a colloid or a suspension.

Paragraph 31: The biocidal aqueous composition of any preceding paragraph further comprising one or more chelating agents, wherein the one or more chelating agents comprise tetrasodium N,N-bis(carboxymethyl)-L-glutamate and optionally wherein the one or more chelating agents are present in an amount of 0.25 to 10 wt. % based on the weight of the aqueous composition, preferably 0.5 to 8 wt. %, 0.75 to 6 wt. % or 1 to 4 wt. %, based on the weight of the aqueous composition.

Paragraph 32: The biocidal aqueous composition of any preceding paragraph further comprising one or more chelating agents, wherein the one or more chelating agents comprise tetrasodium N,N-Bis(carboxymethyl)-L-glutamate and are present in an amount of 1 to 4 wt. %, based on the weight of the aqueous composition.

Paragraph 33: The biocidal aqueous composition of any preceding paragraph further comprising a pH buffer, wherein the pH buffer comprises citric acid and is optionally present in amount of 0.025 to 2 wt. % based on the weight of the aqueous composition, preferably 0.05 to 1 wt. %, 0.075 to 0.75 wt. % or 0.1 to 0.5 wt. %, based on the weight of the aqueous composition.

Paragraph 34: The biocidal aqueous composition of any preceding paragraph, wherein the aqueous composition comprises water in an amount of 20 to 90 wt. % based on the weight of the aqueous composition.

Paragraph 35: A biocidal aqueous composition comprising:
(a) sucrose distearate;
(b) dimethyl succinate;
(c) glycerol; and
(d) one or more of capryl glucoside, lauryl glucoside and coco glucoside,
(e) tetrasodium N,N-bis(carboxymethyl)-L-glutamate,
(f) citric acid, and
(g) water
wherein the aqueous composition is a colloid or a suspension.

Paragraph 36: A biocidal aqueous composition comprising:
(a) 4 to 15 wt. % based on the weight of the aqueous composition of sucrose distearate;
(b) 4 to 15 wt. % based on the weight of the aqueous composition of dimethyl succinate;
(c) 6 to 15 wt. % based on the weight of the aqueous composition of glycerol; and
(d) 10 to 15 wt. % based on the weight of the aqueous composition of one or more of capryl glucoside, lauryl glucoside and coco glucoside,
(e) 1 to 4 wt. %, based on the weight of the aqueous composition of tetrasodium N,N-bis(carboxymethyl)-L-glutamate,
(f) 0.1 to 0.5 wt. % based on the weight of the aqueous composition of citric acid, and
(g) 20 to 90 wt. % based on the weight of the aqueous composition of water wherein the aqueous composition is a colloid or a suspension.

Paragraph 37: The biocidal aqueous composition of any preceding paragraph, wherein the aqueous composition is an oil in water emulsion.

Paragraph 38: Use of a biocidal aqueous composition as defined in any preceding paragraph as a disinfectant.

Paragraph 39: Use of a biocidal aqueous composition as defined in any preceding paragraph as a biocidal agent in bathrooms or kitchens.

Paragraph 40: Use of a biocidal aqueous composition as defined in any preceding paragraph as a biocidal agent in hospitals.

Paragraph 41: Use of a biocidal aqueous composition as defined in any preceding paragraph as a biocidal agent to disinfect surgical and/or equipment.

Paragraph 42: Use of a biocidal aqueous composition as defined in any preceding paragraph as a biocidal agent in food processing facilities.

Paragraph 43: Use of a biocidal aqueous composition as defined in any preceding paragraph as a biocidal agent to treat plants, crops, meat, fruits, vegetables and livestock.

Paragraph 44: A method of manufacturing the biocidal aqueous composition of any of paragraph 1 to 37, comprising the steps of:
(i) mixing a sugar ester and a dialkyl ester with water,
(ii) adding one or more surfactants, and
(iii) adding a humectant.

Paragraph 45: A method of manufacturing the biocidal aqueous composition of any of paragraph 1 to 37, comprising the steps of:
(i) mixing a sucrose ester and a dialkyl ester with water,
(ii) adding one or more surfactants, and
(iii) adding a humectant.

Paragraph 46: The method of paragraph 45, wherein the sugar ester is a sucrose ester, optionally sucrose stearate or sucrose distearate is present in an amount of 1 to 45 wt. % based on the weight of the aqueous composition, optionally wherein the dialkyl ester is dimethyl succinate is present in an amount of 1 to 45 wt. % based on the weight of the aqueous composition, optionally wherein the humectant is present in an amount of 1 to 40 wt. % based on the weight of the aqueous composition, optionally wherein the one or more surfactants are present in an amount of 2 to 45 wt. % based on the weight of the aqueous composition.

Paragraph 47: A method of manufacturing the biocidal aqueous composition of any of paragraph 1 to 37, comprising the steps of:
(i) mixing sucrose distearate and dimethyl succinate with water,
(ii) adding one or more of capryl glucoside, lauryl glucoside and coco glucoside, and
(iii) adding glycerol.

Paragraph 48: The method of any of paragraphs 45 to 47, further comprising adding one or more chelating agents in step (i), preferably wherein the one or more chelating agents are present in an amount of 0.25 to 10 wt. % based on the weight of the aqueous composition.

Paragraph 49: A method of manufacturing the biocidal aqueous composition of any of paragraph 1 to 37, comprising the steps of:
(i) mixing 4 to 15 wt. % based on the weight of the aqueous composition of sucrose distearate and 4 to 15 wt. % based on the weight of the aqueous composition of dimethyl succinate with 20 to 90 wt. % based on the weight of the aqueous composition water,
(ii) adding 6 to 15 wt. % based on the weight of the aqueous composition of one or more of capryl glucoside, lauryl glucoside and coco glucoside, and
(iii) adding 10 to 15 wt. % based on the weight of the aqueous composition of glycerol.

Paragraph 50: A method of manufacturing the aqueous composition of any of paragraph 1 to 37, comprising the steps of:
(i) mixing 4 to 15 wt. % based on the weight of the aqueous composition of sucrose distearate, 0.25 to 10 wt. % based on the weight of the aqueous composition of a chelating agent and 4 to 15 wt. % based on the weight of the aqueous composition of dimethyl succinate with 20 to 90 wt. % based on the weight of the aqueous composition of water,
(ii) adding 6 to 15 wt. % based on the weight of the aqueous composition of one or more of capryl glucoside, lauryl glucoside and coco glucoside, and
(iii) adding 10 to 15 wt. % based on the weight of the aqueous composition of glycerol; and
(iv) adding a pH buffer.

Paragraph 51: A biocidal aqueous composition comprising:
(a) a sugar ester;
(b) a dialkyl ester;
(c) a humectant; and
(d) one or more surfactants,
wherein the composition is a colloid or a suspension, and
wherein the composition achieves a mean reduction of >5^{Log 10} in viable bacteria within 5 minutes.

Paragraph 52: The composition of paragraph 51, wherein the composition achieves a mean reduction of >5^{Log 10} in viable bacteria within 1 minute.

Paragraph 53: The composition of paragraph 51, wherein the composition achieves a mean reduction of >6^{Log 10} in viable bacteria within 5 minutes.

Paragraph 54: The composition of paragraph 51, wherein the composition achieves a mean reduction of >6^{Log 10} in viable bacteria within 1 minute.

Paragraph 55: The composition of claim 51, wherein the viable bacteria is at least one of Pseudomonas aeruginosa, Staphylococcus aureus, Escherichia coli, and Enterococcus hirae.

Paragraph 56: The composition of any of paragraphs 51 to 55, wherein the sugar ester derived from the esterification of a sugar and a fatty acid.

Paragraph 57: The composition of any of paragraphs 51 to 56, wherein the dialkyl ester which is not a sugar ester.

Paragraph 58: The composition of any of paragraphs 51 to 57, wherein the one or more surfactants comprise a glycoside or a combination of glycosides.

Paragraph 59: A biocidal aqueous composition comprising:
(a) a sugar ester in an amount of 4-15 wt. % based on the weight of the aqueous composition;
(b) a dialkyl ester in an amount of 4-15 wt. % based on the weight of the aqueous composition;
(c) a humectant in an amount of 6-15 wt. % based on the weight of the aqueous composition; and
(d) one or more surfactants in an amount of 4-35 wt. % based on the weight of the aqueous composition,
wherein the composition is a colloid or a suspension, and
wherein the composition achieves a mean reduction of >5^{Log 10} in viable bacteria within 5 minutes.

Paragraph 60: The composition of paragraph 59, wherein the composition achieves a mean reduction of >5^{Log 10} in viable bacteria within 1 minute.

Paragraph 61: The composition of paragraph 59, wherein the composition achieves a mean reduction of >6^{Log 10} in viable bacteria within 5 minutes.

Paragraph 62: The composition of paragraph 59, wherein the composition achieves a mean reduction of >6^{Log 10} in viable bacteria within 1 minute.

Paragraph 63: The composition of claim 59, wherein the viable bacteria is at least one of Pseudomonas aeruginosa, Staphylococcus aureus, Escherichia coli, and Enterococcus hirae.

Paragraph 64: The composition of any of paragraphs 59 to 63, wherein the sugar ester derived from the esterification of a sugar and a fatty acid.

Paragraph 65: The composition of any of paragraphs 59 to 64, wherein the dialkyl ester which is not a sugar ester.

Paragraph 66: The composition of any of paragraphs 59 to 65, wherein the one or 5 more surfactants comprise a glycoside or a combination of glycosides.

1. A biocidal aqueous composition comprising:
(a) a sugar ester derived from the esterification of a sugar and a fatty acid in an amount of 4-15 wt. % based on the weight of the aqueous composition;
(b) a dialkyl ester which is not a sugar ester in an amount of 4-15 wt. % based on the weight of the aqueous composition;
(c) a humectant in an amount of 6-15 wt. % based on the weight of the aqueous composition; and
(d) one or more surfactants comprising a glycoside or a combination of glycosides in an amount of 4-35 wt. % based on the weight of the aqueous composition,
wherein the aqueous composition is a colloid or a suspension.

2. The biocidal aqueous composition of claim 1, wherein the sugar ester is a sucrose ester, fructose ester, lactose ester or glucose ester; wherein the sugar ester is a sucrose ester, optionally sucrose stearate or sucrose distearate.

3. The biocidal aqueous composition of claim 1, wherein the dialkyl ester is a dialkyl ester of an acid selected from succinic acid, carbonic acid, glutaric acid or adipic acid, and wherein the dialkyl ester is dimethyl succinate, dimethyl carbonate, dimethyl glutarate or dimethyl adipate.

4. The biocidal aqueous composition of claim 1, wherein the humectant is an alkyl polyol or combination of alkyl polyols; wherein the alkyl polyol or combination of alkyl polyols is an alkyl diol, optionally propylene glycol, butylene glycol or hexylene glycol, or an alkyl triol optionally glycerol, or an alkyl polyol optionally sorbitol or xylitol, or the alkyl polyol is glycerol.

5. The biocidal aqueous composition of claim 1, wherein the one or more surfactants comprise one or more glucosides, wherein the glucosides are selected from one or more of capryl glucoside, lauryl glucoside and coco glucoside and are optionally present in an amount of 7 to 25 wt. % or 10 to 15 wt. %, based on the weight of the aqueous composition.

6. The biocidal aqueous composition of claim 1, further comprising one or more chelating agents, wherein the one or more chelating agents comprise tetrasodium N, N-bis(carboxymethyl)-L-glutamate and are optionally present in an amount of 0.25 to 10 wt. %, 0.5 to 8 wt. %, 0.75 to 6 wt. % or 1 to 4 wt. % based on the weight of the aqueous composition.

7. The biocidal aqueous composition of claim 1, further comprising a pH buffer, wherein the pH buffer is citric acid and optionally wherein the pH buffer is present in amount of 0.025 to 2 wt. %, 0.05 to 1 wt. %, 0.075 to 0.75 wt. % or 0.1 to 0.5 wt. % based on the weight of the aqueous composition.

8. The biocidal aqueous composition of claim 1, wherein the aqueous composition comprises water in an amount of 20 to 90 wt. % based on the weight of the aqueous composition.

9. The biocidal aqueous composition of claim 1, wherein the aqueous composition is an oil in water emulsion.

10. A method of disinfecting a surface, the method comprising applying the biocidal aqueous composition of claim 1.

11. The method of claim 10, wherein the biocidal aqueous composition is applied as a biocidal agent in hospitals.

12. The method of claim 10, wherein the biocidal aqueous composition is applied as a biocidal agent to plants, crops, fruit, vegetables or meat.

13. A method of manufacturing the biocidal aqueous composition of claim 1, comprising the steps of:
(i) mixing a sugar ester and a dialkyl ester with water,
(ii) adding one or more surfactants, and
(iii) adding a humectant.

14. The method of claim 13, wherein the sugar ester is a sucrose ester, optionally sucrose stearate or sucrose distearate is present in an amount of 1 to 45 wt. % based on the weight of the aqueous composition, optionally wherein the dialkyl ester is dimethyl succinate is present in an amount of 1 to 45 wt. % based on the weight of the aqueous composition, optionally wherein the humectant is glycerol and is optionally present in an amount of 1 to 40 wt. % based on the weight of the aqueous composition, optionally wherein the one or more surfactants comprise one or more of capryl glucoside, lauryl glucoside and coco glucoside and are optionally are present in an amount of 2 to 45 wt. % based on the weight of the aqueous composition.

15. The method of claim 13, further comprising adding one or more chelating agents in step (i), wherein the one or more chelating agents are present in an amount of 0.25 to 10 wt. % based on the weight of the aqueous composition and optionally wherein the one or more chelating agents comprise tetrasodium N,N-bis(carboxymethyl)-L-glutamate.

16. A biocidal aqueous composition comprising:
(a) a sugar ester derived from the esterification of a sugar and a fatty acid;
(b) a dialkyl ester which is not a sugar ester;
(c) a humectant; and
(d) one or more surfactants comprising a glycoside or a combination of glycosides,
wherein the aqueous composition is a colloid or a suspension, and
wherein the biocidal aqueous composition achieves a mean reduction of >5^{Log 10} in viable bacteria within 5 minutes.

17. The biocidal aqueous composition of claim 16, wherein the composition achieves a mean reduction of >5^{Log 10} in viable bacteria within 1 minute.

18. The biocidal aqueous composition of claim 16, wherein the composition achieves a mean reduction of >6^{Log 10} in viable bacteria within 5 minutes.

19. The biocidal aqueous composition of claim 16, wherein the composition achieves a mean reduction of >6^{Log 10} in viable bacteria within 1 minute.

20. The biocidal aqueous composition of claim 16, wherein the viable bacteria is at least one of Pseudomonas aeruginosa, Staphylococcus aureus, Escherichia coli, and Enterococcus hirae.
